(19) United States
(12) Patent Application Publication
(10) Pub. No.: US 2026/0166781 A1
(43) Pub. Date: Jun. 18, 2026

(54) METHOD FOR RECYCLING POLYOLEFIN CONTAINERS

(71) Applicant: ALPLA WERKE ALWIN LEHNER GMBH & CO. KG, Hard (AT)

(72) Inventors: Cornelius Amann, Schnifis (AT); Michael Heyde, Bergisch Gladbach (DE)

(21) Appl. No.: 18/707,878

(22) PCT Filed: Nov. 4, 2022
(86) PCT No.: PCT/EP2022/080835

§ 371 Date: May 6, 2024

(30) Foreign Application Priority Data
Nov. 5, 2021 (CH) 070509/2021

(51) Int. Cl. B29B 17/02; B29B 9/06; B29B 17/00; B29B 17/04; B29K 23/00; B29L 31/00

(52) U.S. Cl. CPC B29B 17/02; B29B 9/06; B29B 17/0412; B29B 2017/0015; B29B 2017/0203; B29B 2017/0244; B29B 2017/0289; B29B 2017/0296; B29B 2017/0468; B29K 2023/00; B29L 2031/712

(57) ABSTRACT

The invention relates to a method for recycling polyolefin containers, comprising container sorting, intensive wash with comminution of the containers to form flakes, friction wash and density separation, a cleaning step, flake sorting, extrusion and granulation of the cleaned flakes. The cleaning step comprises a percolation of the flakes with cold sodium hydroxide solution at a temperature of <60° C., and a first deodorization of the flakes with steam carried out subsequently to the cleaning.

### CROSS-REFERENCE TO RELATED APPLICATIONS

This application is a national phase entry under 37 U.S.C § 371 of PCT/EP 2022/080835 filed Nov. 4, 2022, which claims priority to Swiss Patent Application No. CH070509/2021 filed Nov. 5, 2021, the entirety of each of which is incorporated by this reference.

### FIELD OF THE INVENTION

The invention relates to a method for recycling polyolefin containers by forming flakes, cleaning the flakes, extruding the flakes and granulating.

### PRIOR ART

Polyolefins belong to the most widespread plastic types of the world, and recycling this type of plastic is of particular importance for the use of existing resources. Impurities in the material lead to an impaired discoloration, to an unpleasant odor, and to impurities which do not allow further use in the food sector. Closed recycling circuits in which, for example, HDPE milk bottles are reused to create milk bottles are prior art. Recycling is only successful because a clearly defined input stream without the usual contamination is used for recycling. With the usual contaminants which, for example, empty washing agent containers, fuel canisters, shampoos and other non-food packagings have, this high-quality recycling without contaminants is very complicated, if at all possible. In particular, the strong odor prevents many packaging manufacturers from using polyolefin regenerates.

State of the art methods pass the recycled granules into an air stream, a vacuum, a nitrogen stream or steam and thereby deodorize them. In particular, steam is effective for removing odors, as is disclosed in WO 2013/072035 A1. The removal of the odors is usually the more intensive the higher the temperature used for the deodorization. However, at 120 to 130° C., an upper limit is reached, since the granules melt and adhere above this temperature.

To be cleaned, polyolefin packaging, either as a bottle or ground as flakes, is also washed intensively in order to remove adhering adhesives, labels, sleeves or residues of the filling material. This washing is usually carried out in a cold preliminary wash and a hot post-wash about (40° C. to 90° C.). The temperature should especially help remove so-called hot adhesives as used for applying the labels. A1 to 3% NaOH caustic solution, which is to intensify the washing process supported by surfactants, is usually used as washing water. However, the washing process can only remove impurities on the surface of the material, but not impurities which have penetrated deep into the material.

### ADVANTAGES OF THE INVENTION

Given the disadvantages of the described prior art, the present invention results in freeing recycled polyolefins as completely as possible from unpleasant odors so that a mixed stream of different polyolefin packaging can be recycled, and the flakes and containers newly produced from the mixed stream have no or very low annoying odor.

### SUMMARY OF THE INVENTION

The stated advantages are achieved with a method for recycling polyolefin by the features identified in the independent claim. Developments and/or advantageous alternative embodiments form the subject-matter of the dependent claims.

The invention includes a cleaning step that comprises a percolation c1 of the flakes with sodium hydroxide solution at a temperature <60° C., and a first deodorization c2 of the flakes with steam subsequent to step c1. The flakes are transferred from the cold washing to a sodium hydroxide percolation reactor in which the flakes are wet on the surface with cold sodium hydroxide solution (temperature <60° C.) in order to dissolve adhesive residues and contaminants on the surface so that they can be removed more easily by the steam. Subsequently, the mixture of flakes with residues of sodium hydroxide solution is then steamed with a large amount of steam in the steam deodorization process in order to entrain the volatile and odor-causing substances with the steam, and obtain resulting in flakes with a very low odor. The combination of cold sodium hydroxide solution, steam and heat only on the surface ensures very good cleaning results. These can be improved even if the steam supply is in several stages, which leads to the fact that the contaminating substances are entrained even more effectively.

The still cold flakes after the cold washing pick up fewer impurities since the material is still cold in the interior, and the migration of odorous substances into the material in a cold state is significantly lower. The steam, which condenses on the surface of the flakes, interacts with the excess steam flowing past so that water and other contaminants, even if they have a higher boiling point than water, are entrained by the steam droplets that come off.

The energy that is used by the steam treatment is not lost since the flakes are heated by the steam, and accordingly less energy has to be used for melting and granulating. The water that condenses from of the steam on the flakes and is in excess is removed with the adhesive residues from the flakes before the extruder and granulation. Ideally, the extruder includes degassing for granulation in order to additionally remove even small odor-intensive molecules.

The use of hot steam instead of a hot caustic solution has the positive addition effect that large organic molecules react with the caustic solution and break up into many small odor-intensive organic compounds, but these reactions with steam do not occur. The saponification of fats and oils, which breaks down the caustic solution and produces small odor-intensive molecules, is well known. However, hydrolysis also involves to other large molecules such as egg white and carbohydrates. A caustic solution can attack many organic compounds and break them down in odor-intensive small molecules. The hotter the caustic solution, the more intensive the breakdown reactions, and the more intensive the loading with odor-intensive molecules in the hot wash, which can penetrate deep into the polyester matrix.

In a particular embodiment of the invention, in step c2, the steam entrains the sodium hydroxide solution from the surface of the flakes. As a result, steam and sodium hydroxide solution, which are loaded with impurities and adhesive residues, are removed together from the flakes.

The contaminated sodium hydroxide solution and the contaminated steam are expediently separated from one another in a separation h. As a result, the steam can emit its thermal energy in a heat exchanger before it is supplied to a wastewater treatment.

It has proven to be advantageous if, after step e, a second deodorization f of the regranulate is carried out. The quality of the regranulate is thereby further improved. For example, the second deodorization can take place in a conventional degassing system. In this case, steam, nitrogen and air can serve as degassing media, wherein the inflow can be designed in multiple parts or in multiple stages. This has the advantage that the heat profile is more homogeneous over the bulk height, and the degassing is thereby more sustainable and more effective. It is also possible for the extruder to have degassing for the granulation in order to additionally remove even small odor-intensive molecules.

The waste water of the intensive wash, the contaminated sodium hydroxide solution and the contaminated steam are expediently fed to a wastewater treatment g. The steam is previously condensed in a heat exchanger, and accordingly all three wastewaters can be supplied to a common wastewater preparation. All three wastewaters have similar contaminants, namely dissolved adhesive residues and odor-intensive dissolved substances.

In a further embodiment of the invention, the flake sorting d is carried out before percolation c1, after percolation c1 or after the first deodorization c2. These embodiments of the different position of the flake sorting in the process sequence have the effect that extremely pure-colored fractions are produced, and therefore so-called “cross contaminations” can be largely avoided.

It has proven to be advantageous if intensive washing b is carried out with water at a temperature <60° C. As a result, the containers or flakes are roughly cleaned, and water-soluble impurities are removed. After intensive washing, the flakes have a low temperature, as a result of which odorous substances do not penetrate into the polymer matrix.

In a further embodiment of the invention, the contaminated steam in a heat exchanger i transfers its residual heat to water provided for steam generation for preheating. The excess steam and its energy, as well as the contained small odor-intensive molecules, are guided through the heat exchanger, and the energy is used for further steam production. The condensate including the odor-intensive substances and contaminants is supplied to wastewater treatment.

It has proven expedient if the preheated water is evaporated in a steam generator j to form steam. This means that the production of the steam for absorbing the odor-intensive molecules can be implemented in a particularly energy-saving manner.

The invention also provides that the flakes may be preheated by the step c2 for the step e. The flakes are therefore melted during extrusion as energy-saving as possible, whereby the total energy requirement of the recycling process is further reduced.

It has proven to be advantageous if, after step c or d, rinsing and draining k of the flakes takes place. The aim of this step is to prevent residues of the sodium hydroxide solution from being entrained into the following method steps, and to ensure that flakes can be processed further as dry as possible.

### BRIEF DESCRIPTION OF THE DRAWINGS

Further advantages and features will become apparent from the following description of an embodiment of the invention with reference to the schematic drawings. In the figures, in a representation that is not to scale:

FIG. 1: Shows a flowchart of a recycling method in a first embodiment;

FIG. 2: Shows a flow chart of the recycling process in a second embodiment, and

FIG. 3: Shows a flow chart of the recycling process in a third embodiment.

### DETAILED DESCRIPTION OF THE INVENTION

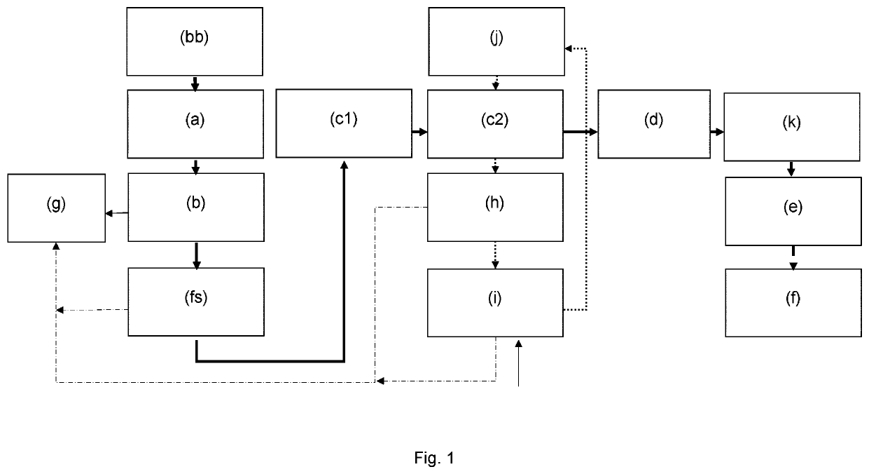

FIG. 1 to 3 each show a flow diagram for recycling polyolefin containers. For all three embodiments, bales of collected polyolefin containers, in particular bottles, which have been supplied for recycling, serve as starting material.

The bales are opened, and the containers are separated onto a conveyor belt (step bb, bale breaking). In step a, the containers are supplied to color sorting. The color-sorted containers are washed in intensive washing b with cold water (temperature <60° C.). This takes place in a friction washer. The containers are shredded into flakes and mechanically separated from the washing water (step fs, flake separation, density separation).

In step c1, the flakes are wet with cold sodium hydroxide solution in a percolation. In so doing, adhesive residues which originate from labels and other impurities on from the container surface are dissolved or released. The cold sodium hydroxide solution has a temperature <60° C.

In contrast to the usual cleaning step with hot 1 to 3% caustic sodium hydroxide solution at 40 to 90° C., the sodium hydroxide solution is cold at a temperature <60° C. The hot sodium hydroxide solution reliably dissolves so-called hot-melt adhesives, especially if the washing process is intensified with surfactants. However, the hot washing process has the disadvantage that it amplifies the odor of the recycled flakes:
If the polyolefin flakes are heated together with the residues in the polyolefin packaging, the adhesives, and the food residues are heated in the hot caustic solution, small organic compounds migrate into the polyolefin matrix at this high temperature and ensure even more intensive odor load. The migration of these small molecules into the material depends on the temperature and drives small odor-intensive molecules into the material as a negative effect of the surface cleaning. Particularly affected are odor-intensive organic acids such as butyric acid, valeric acid, the aldehydes octanal, nonanal, decanal, undecanal, dodecanal, lactones, mineral oil saturated hydrocarbons (MOSH) and mineral oil aromatic hydrocarbons (MOAH).

Another disadvantage of the hot cleaning step is that organic structures in a caustic solution not only dissolve well, but also large organic molecules react with the caustic solution and break up into many small odor-intensive organic compounds. The saponification of fats and oils, which breaks down the caustic solution and alters small odor-intensive molecules, is well known. However, hydrolysis also involves to other large molecules such as egg white and carbohydrates: A hot A caustic solution can attack many organic compounds and break them down in odor-intensive small molecules. The hotter the caustic solution, the more intensive the breakdown reactions, and the more intensive the loading with odor-intensive molecules in the hot wash. In addition to the existing small molecules, these broken up small molecules cause increased migration into the polyolefin matrix and a correspondingly greater odor load in the recycled flakes or granules.

Following step c1, the flakes of a first deodorization c2 are exposed to steam. In this case, the flakes are steamed with a large amount of steam in order to entrain the volatile and odorous substances with the steam and clean the flakes from adhesive residues and other impurities. Resulting therefrom, clean flakes with very low odor are obtained. It therefore makes more sense not to wash flakes hot after the intensive washing b, but to wet them with NaOH (percolate, c1) and clean them with steam (c2) in order to significantly improve the odor of the regranulates and products made from them later.

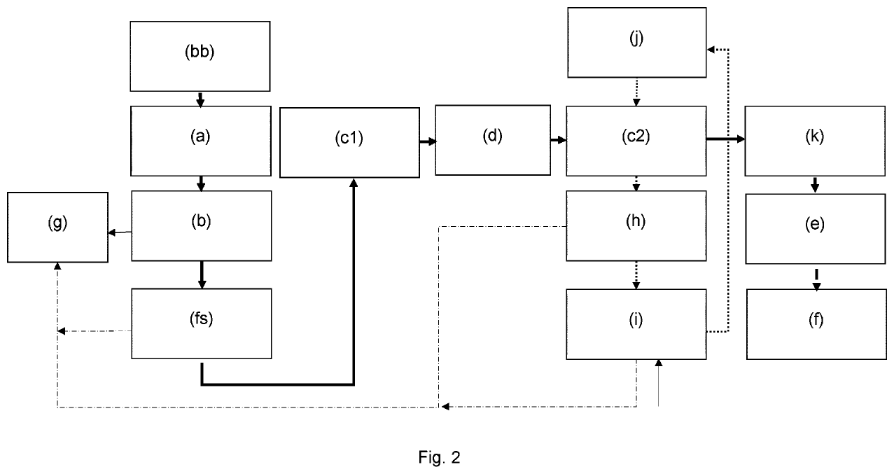

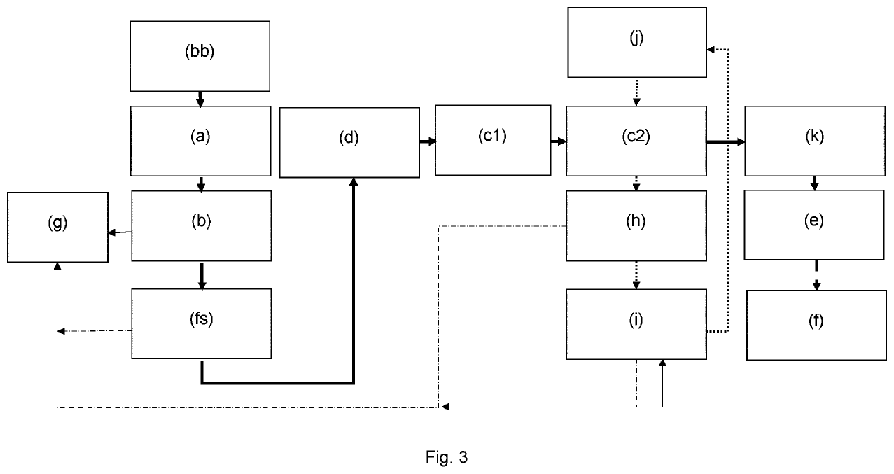

The purified flakes are sorted in a flake sorting d and extruded in step e and granulated to form regranulates. As shown in FIGS. 2 and 3, the flake sorting d can also be before step c1 or c2. This has the effect that extremely pure-colored fractions arise, and therefore so-called cross-contaminations can be largely avoided. Since the flakes are preheated by the steam, they require only a low heat input while melting in the extrusion e. The regranulates can be subjected to a second deodorization f in addition to steam treatment c2, for example with a degassing system (venting system).

After step c or d, the flakes are rinsed and drained k. This prevents sodium hydroxide solutions residues from being entrained into the following method steps, and the flakes can be processed further as dry as possible.

The steam, together with the sodium hydroxide solution entrained by the surface of the flakes, passes into a separation h. In separation h, the steam is separated from the sodium hydroxide. The sodium hydroxide solution is supplied in the same way as the washing water of the intensive wash of a wastewater treatment g. The steam is conducted via a heat exchanger i in which it releases heat and condenses. The steam contaminated and condensed with impurities is likewise supplied to the wastewater treatment g.

In the heat exchanger i, water is preheated by the used steam for steam generation. The preheated water is converted into steam in a steam generator j, which steam is supplied to step c2.

1. A method for recycling polyolefin containers, comprising the
sorting polyolefin containers by color,
friction washing and comminuting the polyolefin containers to form flakes, density separating the flakes from washing water,
cleaning the flakes by percolating the flakes with cold sodium hydroxide solution at a temperature of <60° C., performing a first deodorization of the flakes with steam,
sorting the flakes, and
extruding the flakes and granulating the extrusion.

2. The method according to claim 1, wherein the steam entrains the sodium hydroxide solution from the surface of the cleaned flakes.

3. The method according to claim 2, further comprising separating contaminated sodium hydroxide solution and the contaminated steam are separated from one another.

4. The method according to claim 1, further comprising performing a second deodorization of the granulated extrusion is carried out.

5. The method according to claim 1, further comprising supplying wastewater from the friction washing, contaminated sodium hydroxide solution and contaminated steam to a wastewater treatment.

6. The method according to claim 1, wherein sorting the flakes is carried out before percolating, after percolating or after the first deodorization.

7. The method according to claim 1, wherein the friction washing (b) is carried out with water at a temperature <60° C.

8. The method according to claim 2, further comprising passing the steam through a heat exchanger to pass residual heat from the steam to preheat water provided for steam generation.

9. The method according to claim 8, wherein the preheated water is evaporated to steam in a steam generator.

10. The method according to claim 1, wherein the flakes are preheated by the steam for the extruding.

11. The method according to one claim 1, further comprising rinsing and draining of the flakes after cleaning or sorting the flakes.
